(19) United States
(12) Patent Application Publication
(10) Pub. No.: US 2025/0227587 A1
(43) Pub. Date: Jul. 10, 2025

(54) COMMUNICATION SYSTEMS AND METHODS FOR PERSONAL PROTECTION DEVICES

(71) Applicant: 3M INNOVATIVE PROPERTIES COMPANY, St. Paul, MN (US)

(72) Inventors: Kristina Gustafsson, Värnamo (SE); Patrick R.T. Hjort, Värnamo (SE); Abel Gladstone Mangam, Värnamo (SE)

(21) Appl. No.: 18/853,814

(22) PCT Filed: Mar. 30, 2023
(86) PCT No.: PCT/IB2023/053199

§ 371 Date: Oct. 3, 2024

Related U.S. Application Data
(60) Provisional application No. 63/362,605, filed on Apr. 7, 2022.

(51) Int. Cl. H04W 36/18; H04W 36/32; H04W 36/36; H04W 48/18

(52) U.S. Cl. CPC H04W 36/18; H04W 36/322; H04W 36/36; H04W 48/18

(57) ABSTRACT

A communication selection system for a personal protective network is presented. The system includes a network detector that detects an available network for a second device in the personal protective network. The system also includes a network selector that selects the available network and switches a communication component from using a first device, on a first network to the second device on the available network. The switch is based on an indication that the communication device is leaving a range of a current network communication protocol. A communication component stops using the first network communication protocol and starts using the available network communication protocol. The switch from the current network to the available network happens substantially seamlessly.

### BACKGROUND

Consistent with evolving rules and regulations related to safety, safety is an important concern in any workplace. Companies or businesses employing workers wearing articles of PPE also want to ensure that workers are complying with relevant laws, regulations and company policies related to proper use and maintenance of PPE.

Of particular concern is the ability for workers to maintain safety while also being able to communicate with one another. Different communication options exist for communicating in noisy environments.

### SUMMARY

A communication selection system for a personal protective network is presented. The system includes a network detector that detects an available network for a second device in the personal protective network. The system also includes a network selector that selects the available network and switches a communication component from using a first device, on a first network to the second device on the available network. The switch is based on an indication that the communication device is leaving a range of a current network communication protocol. A communication component stops using the first network communication protocol and starts using the available network communication protocol. The switch from the current network to the available network happens substantially seamlessly.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIGS. 1A and 1B illustrate worksites in which embodiments of the present invention may be useful.

FIG. 2 illustrates a communication selection system for a personal protective equipment device in accordance with embodiments herein.

FIG. 3 illustrates an example method of configuring a communication system in accordance with embodiments herein.

FIG. 4 illustrate an example method of switching a network for a communication device in accordance with embodiments herein.

FIG. 5A-5C illustrates an example user interface presented to a user of a PPE device in accordance with embodiments herein.

FIGS. 6A-6C illustrate example PPE that may be used in accordance with embodiments herein.

FIG. 7 illustrates a block diagram of an example environment in accordance with embodiments herein.

FIGS. 8-10 illustrate example devices that can be used in embodiments herein.

### DETAILED DESCRIPTION

Improved methods and systems for ensuring safety compliance while also providing sufficient communication methods in a work environment are needed. Many environments require workers or individuals to wear personal protective devices that make verbal communication difficult or unsafe. For example, hearing protection is required for environments with a lot of noise. It is possible to use a 2-way radio to communicate with another individual, or to use a Natural Interaction Behavior (NIB) protocol. However, 2-way radio limits a number of individuals that can be in a conversation, and only offers a half-duplex communication where a single user can speak at a time. NIB offers more speaker slots, but limits a physical range between the individuals in the conversation. In many cases, an individual has to “call in” using a mobile phone to maintain a conversation. This can result in individuals being on a phone call the entire work shift. As a result, it makes it difficult to handle any other incoming calls, as the work conversation would have to end, and the worker would then have to re-dial into the call.

NIB is a preferred communication platform for high noise environments because it enables short-range headset-to-headset communication without the use of external radio. NIB also eliminates the need for pairing and frequency selection. Four or more individuals may be able to speak using NIB, for example, and over 60 individuals may be able to listen at any given time within a 10-meter radius. Audio is activated by a voice activated switch (VOX) for hands free operation, or can be activated by push-to-talk. VOX provides a benefit in adaptability, because the threshold to activate can adjust automatically to the noise level in the environment.

Further, communication modes are currently isolated from one another, so that communications cannot take place, for example, between a mobile phone on a cellular network and a 2-way radio. A user has to manually change the communication mode. This can be difficult in scenarios where a worker is actively using both hands or actively concentrating in a task at hand.

It is desired to have a system where a 2-way radio, NIB/ISRD and Bluetooth® all connect to the headset. It is desired for the headset to be aware of what communication mode is active and able to seamlessly switch from one communication mode to another, based on the wearer's needs, with minimal to no effort from the user. This may be done automatically, for example, by switching from NIB to cellular as the user nears the edge of an NIB range.

Embodiments herein describe such a system as incorporated into a hearing protection unit—e.g. into in-ear buds or over-the-ear muffs. However, it is expressly contemplated that such systems may be incorporated into other PPE devices or systems. For example, a user wearing a PAPR may have speakers inside a hood, in a separate hearing protection unit, or projecting from a control unit or other communications unit. Systems and methods herein envision a processor able to detect a current communication network, a limitation of the current network, a potential communication network and a trigger to switch between the current network to the potential network. Systems and methods herein concern a PPE device with such a processor that can handle such a process without consultation with, or command from, a base station. The handover from a first communication mode to a second communication mode happens on a single device.

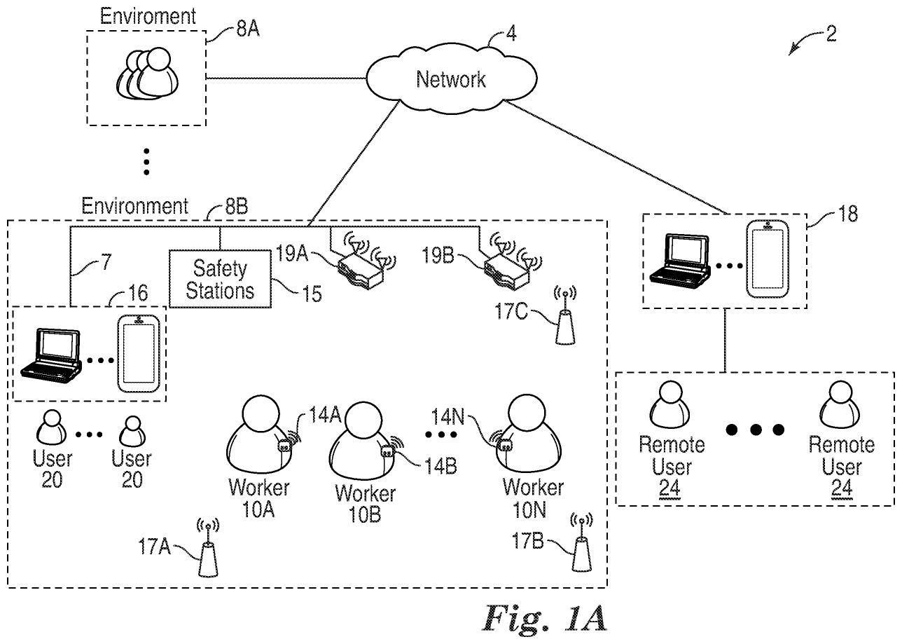

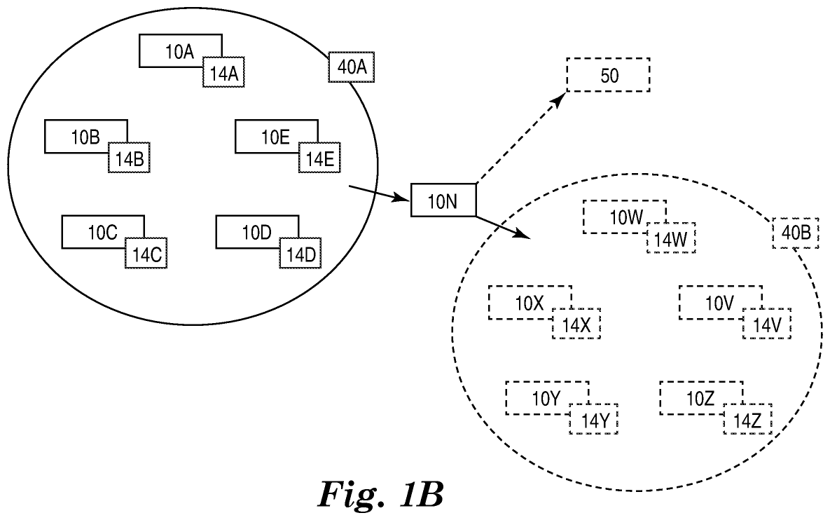

FIGS. 1A and 1B illustrate worksites in which embodiments of the present invention may be useful. FIG. 1A is a block diagram illustrating an example environment 2 for a worksite 8A or 8B. The worksite environments 8A and 8B may have one or more workers 10A-10N, each of which may need to interact with equipment or environments that require the use of personal protective equipment such as glasses, hard hats, fall protection equipment, respirators, gloves, etc. Workers 10A-10N may have a range of experience with a given worksite, with some knowing and complying with safety rules, and others who do not know, are still in training, or actively not complying with all safety requirements. Workers 10A-10N may need to communicate with each other during a shift. For example, worker 10A may need to leave environment 8B to retrieve equipment from environment 8A. It is desired for worker 10A to be able to maintain an open communication line with workers 10B-10N.

Environments 8A or 8B may optionally have a wireless network 4, through which data may be collected or communicated, for example to one or more devices or displays 16 within an environment, or devices or displays 18, remote from the environment. Alerts may be provided to workers 10A-10N using network 4.

As shown in the example of FIG. 1A, worksite 2 represents a computing environment in which a computing device within of a plurality of physical environments 8A, 8B (collectively, environments 8) electronically communicate using one or more networks 4. Each of physical environments 8A and 8B represents a physical environment, such as a work environment, in which one or more individuals, such as workers 10, utilize personal protection equipment while engaging in tasks or activities within the respective environment. 15

While only a single network 4 is illustrated, it is expressly contemplated that multiple network protocols may be available within worksite 2. Communication protocols may include NIB, cellular, WIFI™, Bluetooth™, 802.11 wireless networks, 802.15 ZigBee networks, or another suitable wireless network.

In this example, environment 8A is shown as generally as having workers 10, while environment 8B is shown in expanded form to provide a more detailed example. In the example of FIG. 1A, a plurality of workers 10A-10N may be wearing a variety of different PPE, such as ear muff hearing protectors, in-ear hearing protectors, hard hats, gloves, glasses, goggles, masks, respirators, hairnets, scrubs, or any other suitable personal protective equipment. 25

In some embodiments herein, an article of PPE may include one or more of embedded sensors, communication components, monitoring devices and processing electronics. In addition, each article of PPE may include one or more output devices for facilitating communications between worker 10A-10N. Additionally, PPE may include one or more devices to generate audible feedback (e.g., one or more speakers), visual feedback (e.g., one or more displays, light emitting diodes (LEDs) or the like), or tactile feedback (e.g., a device that vibrates or provides other haptic feedback).

Environment 8B includes a plurality of wireless access points 19A, 19B that may be geographically distributed throughout the environment to provide support for wireless communications throughout the work environment. As shown in the example of FIG. 1A, an environment, such as environment 8B, may also include one or more wireless-enabled beacons, such as beacons 17A-17C, that provide accurate location information within the work environment. For example, beacons 17A-17C may be GPS-enabled such that a controller within the respective beacon may be able to precisely determine the position of the respective beacon. Alternatively, beacons 17A-17C may include a pre-programmed identifier that is associated with a particular location. Based on wireless communications with one or more of beacons 17, or data hub 14 worn by a worker 10, the location of the worker within work environment 8B can be determined.

Environment 8B, may also include one or more safety stations 15 distributed throughout the environment to provide viewing stations. Safety stations 15 may allow one of workers 10 to check out articles of PPE and/or other safety equipment, verify that safety equipment is appropriate for a particular one of environments 8, and/or exchange data. For example, safety stations 15 may transmit alert rules, software updates, or firmware updates to articles of PPE or other equipment.

In addition, each of environments 8 include computing facilities that provide an operating environment for end-user computing devices 16 for interacting with devices on network 4. For example, each of environments 8 typically includes one or more safety managers or supervisors, represented by users 20 or remote users 24, are responsible for overseeing safety compliance within the environment. In general, each user 20 or 24 interacts with computing devices 16, 18 to access devices on network 4. For example, the end-user computing devices 16, 18 may be laptops, desktop computers, mobile devices such as tablets or so-called smart cellular phones.

FIG. 1B illustrates a worker 10N, with a PPE 14 that includes a wireless communication component, at a point during a shift in a worksite environment. Worker 10N has just left the range of a first NIB network 40A. Worker 10N, based on known locations of workers 10A-10E and workers 10V-10Z, may be heading toward workers 10V-10Z, in network 40B. Alternatively, based on a known task or operation assigned to worker 10N, they may instead be heading toward another area 50 (e.g. restroom, equipment room, etc.), and then back to the group of workers 10A-10E.

NIB has a physical distance limitation. In the scenario where worker 10N is intending to return to a first task where conversation with workers 10A-10E will resume, it may be helpful for a task to keep worker 10N connected to a conversation. While FIG. 1B illustrates worker 10N moving laterally through a worksite, it is possible that they are also moving vertically-such as ascending a ladder or crane. In such situations, it may be imperative for safety reasons to keep worker 10N connected. Additionally, it is understood that, for a worker 10N to have to take the time, concentration, and dexterity to manually switch to a different communication protocol, could be dangerous as well as inefficient.

Currently, a working solution is to maintain a cellular connection between workers, but that prohibits worker 10N from taking an incoming call. Additionally, NIB is intended for group conversations with 8 or more individuals, for example, communicating at the same time.

Many PPE, including headsets, can use either of 2-way or cellular communication. In embodiments herein, PPE can detect whether a wireless communication protocol is available when worker 10N is detected as approaching a range limit of NIB network 40A. PPE 14 may then be able to automatically switch from the NIB protocol to a 2-way radio, ISRD or the cellular network and call into the NIB network. Automatic switching may occur in the background, without consultation of worker 10N, so that a seamless transfer is available.

Each device, when manufactured, is assigned a unique ID number. When a number of devices are in proximity of each other, the device with the lowest ID number creates the NIB network and takes the lowest timeslot, effectively acting as the “master” of the network. However, if the device in the lowest timeslot leaves the network, the device with the next lowest ID number moves into the lowest timeslot and maintains the network. However, other methods of forming a network and assigning a master device on the controller are possible.

Each device in the NIB network keeps track of what devices are connected to a conversation, collecting information about how each device is connected and how to reconnect if audio loss is experienced. For example, Steve's device has the lowest ID number and starts the network. Jay's device and Le's device also join. Le's device detects Steve's device on the network and associates Steve's device with contact information for rejoining the network if needed—for example a cell phone number that can be used to call Steve's cell phone. Each individual device uses logic, as described herein, to decide whether to stay in, or leave, an NIB network. The connection plans are tracked and updated frequently. For example, if Steve's device leaves the network, Le's device may then retrieve information to contact Jay's device if needed. Additionally, either Jay's device or Le's device may, but does not necessarily need to, move into the lowest timeslot and take over the “master” position. Steve may have his device set up to automatically call into the NIB network so that communication is maintained. Steve's device automatically retrieves contact protocol information for either Le or Jay and initiates the protocol. For example, Steve's device may, using a Bluetooth® (or other suitable wired or wireless coupling) connect to Steve's cell phone. Steve's device initiates a call from Steve's cell phone to Jay's cell phone. Jay's device is similarly coupled to Jay's cell phone so that Steve is able to have a full duplex connection into the NIB network, able to hear what Jay hears and communicate through Jay's communication set up. While the embodiment of cellular-to-NIB coupling is described here in detail, it is expressly contemplated that other communication protocols may be paired—e.g. 2-way Radio to NIB, or ISRD to NIB. Steve's device may also retrieve updated NIB network information from Jay's phone so that, if Jay also leaves, Steve's device may be able to call back into the network by calling Jay's device or by knowing, through Steve's device, that Noah's device was added after Steve left and before Jay left.

Prior art allowed network communication using a single technology protocol—e.g. either all on cellular, all on 2-way radio, or all using NIB. The ability to use different communication protocols within a single communication represents a significant increase in flexibility and ability to maintain connection between workers in an environment beyond the distance limitations of NIB alone.

However, it is also contemplated that, while it is detected, for example using a location sensor associated with worker 10N, PPE 14, or a beacon within an environment, that worker 10N is leaving environment 40A, it may not be readily apparent where worker 10N is going, or likely that worker 10N does not want to stay in the current network. Therefore, in some embodiments, systems and methods herein may prompt worker 10N to provide additional information. For example, using visual, audible or haptic feedback, worker 10N may be queried as to whether they would like to stay in network 40A, switch to network 40B, or leave both.

If worker 10N indicates a desire to be part of a conversation ongoing using network 40A or 40B, systems and methods herein then determine an available secondary protocol, other than NIB, and automatically switch communication protocol for device 14N. If worker 10N then returns within a range of network 40A, or enters a range of network 40B, systems and methods herein may then switch device 14N to an NIB protocol.

In some embodiments herein, worker 10N has multiple PPE devices, each of which may have a microphone and/or speaker unit. Worker 10N may then be considered to have a personal area network (PAN) that routes communication between different PPE devices, based on user preferences or communication optimization. For example, in-ear headphones have a preferred speaker to that of a communications unit on a user's chest. However, a boom microphone associated with over-ear protection is preferred over a microphone associated with in-ear headphones. Systems and methods herein, in addition to selecting a preferred network, may also adjust signal routing between different PPE devices associated with a worker 10N.

Selection of a network preference (e.g. NIB or cellular), may be done automatically based on a number of factors. For example, a user may have a preference, e.g. to avoid using cellular networks whenever possible. A safety officer may have a preference for a worksite, e.g. to keep worker 10N in conversation with workers 10A-10E based on a work assignment, unless worker 10N overrides. Preferences may be set to require vocal, accelerometer (e.g. head nodding), or other feedback from worker 10N before a communication mode is changed, or before worker 10N is dropped from a current conversation.

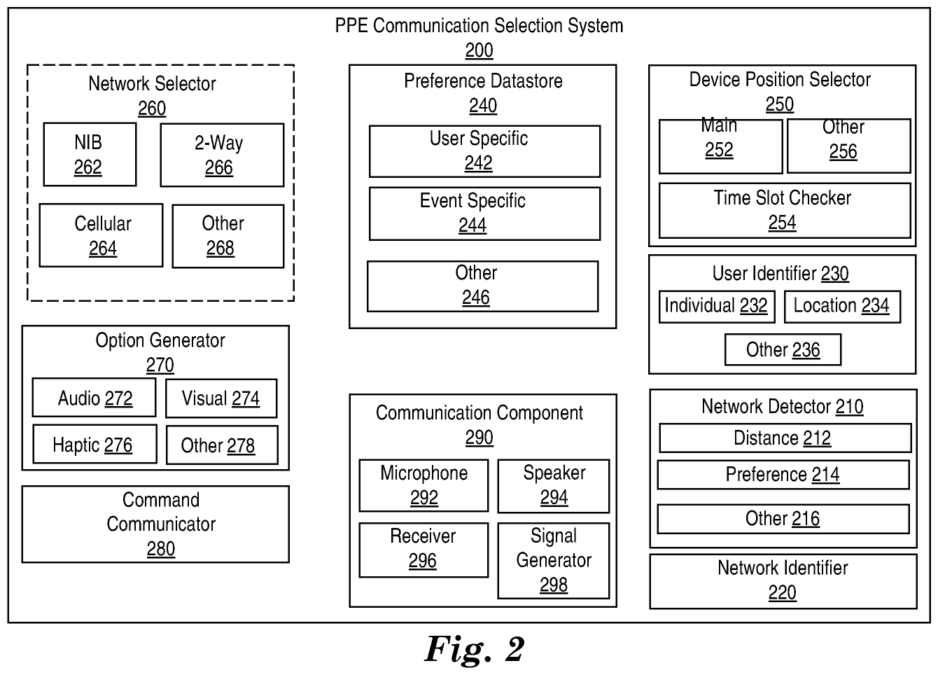

FIG. 2 illustrates a communication selection system for a personal protective equipment device in accordance with embodiments herein. System 200 may be incorporated into a PPE device locally, such that network switching can be done by the PPE device without communicating over a network, e.g. with a base station. In some embodiments, system 200 may be incorporated into a first PPE device and send network switching instructions to other PPE devices, such as described in U.S. Published Patent Application US 2018/0167940 A1, published on Jun. 14, 2018. System 200 may also be remote from a PPE device, for example incorporated into a computing unit that sends/receives data to/from devices within the worksite.

System 200 includes a network detector 210 that detects one or more available networks that a communication component 290 can connect to. Network detector 210 may detect available networks based on distance 212, based on a user preference 214, or based on another preference. For example, network detector 210 may disregard 2-way radio networks available based on a work detail of a user that indicates a user's need to converse with a larger number of people. Detecting a network, using network detector 210, may include querying known networks to determine whether or not a connection is available—e.g. if a worker is returning to an area where they previously were connected to an NIB network, network detector 210 may, upon indication that a worker is approaching that previous location, search for the NIB network.

Network detector 210 may also detect networks based on preferences 214, for example preferences of a PPE user, of a worksite safety manager, of a manufacturer, etc. For example, NIB may be a preferred network selection, and cellular may be used as the first alternative for a first user, while a second user prefers using cellular service to call into an NIB network as a primary connection option. Network detector 210 may have other functionality.

Network identifier 220 may identify a detected network as one that is suitable to join, or not suitable to join. For example, a secured network may be within proximity of a user, but network identifier 220 may detect that user is not authorized to join, is not part of the group of workers associated with the secured network, or otherwise determines that user should or should not join a particular network. For example, referring back to FIG. 1B, if it is indicated that worker 14N is more likely approaching storage locker 50, instead of the second group of people, network identifier 220 may identify network 40B as a network that is not of interest to a given worker.

Network selector 260 may, based on available networks, select to join one using an appropriate communication protocol, e.g. an NIB protocol 262, a 2-way radio protocol 266, a cellular protocol 264, or another suitable protocol 268. Network selector 260 may, as necessary, cause command communicator 280 to communicate another device to change signal routing settings. For example, a first command may be generated by command communicator 280 and communicated to a cellular phone to initiate a call into an existing network and, when the call connects, a second command may be generated to end an NIB connection with the same network. Command communicator 280 may also receive commands from other devices, e.g. to change a device position, using device position selector 250, into a main position 252, for example.

In some embodiments, system 200 can identify a user using a user identifier 230. In some embodiments, a worker is assigned a PPE device and, therefore, can be identified when the PPE device is actuated. The worker may be known as an individual 232, e.g. Steve, and/or may be known as associated with previous work history. For example, the PPE device may previously have been in a networked communication with workers A, B and C. Therefore, when workers A, B and C are in range of the PPE device, the device may automatically join an existing network connecting workers A, B and C when available.

In another example, if worker A, B, and C have actively had conversations over cellular or 2-way radio recently when they have been out of range of an NIB network, their PPE devices automatically select to join the NIB network when it is detected that they are in range. This allows worker A to call worker B or C about an issue and, when all three are in range, they can join a single networked communication to solve the issue.

In another example, workers are assigned to NIB networks based on an employer designation or a shift officer's selection. They may be assigned based on having previously worked together, or by referencing another data source, such as a calendar with a meeting invite containing the specified individuals.

User identifier 230 may also identify a worker based on a location 234 of the PPE device. For example, because a worker is in a particular area of a worksite, it may be assumed that they should be in a networked conversation with other workers in that area. The decision may be safety-based—e.g. because of an ongoing operation, all individuals in an area must be aware of each other, or may be assignment based—e.g. all workers need to know who is doing what since they are not in visual range of each other. User identifier 230 may also use other indicia 236 to identify a user.

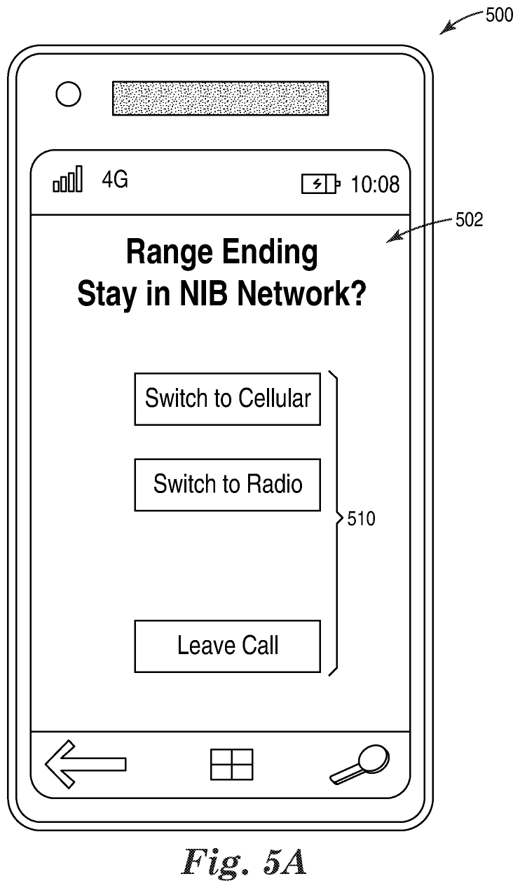

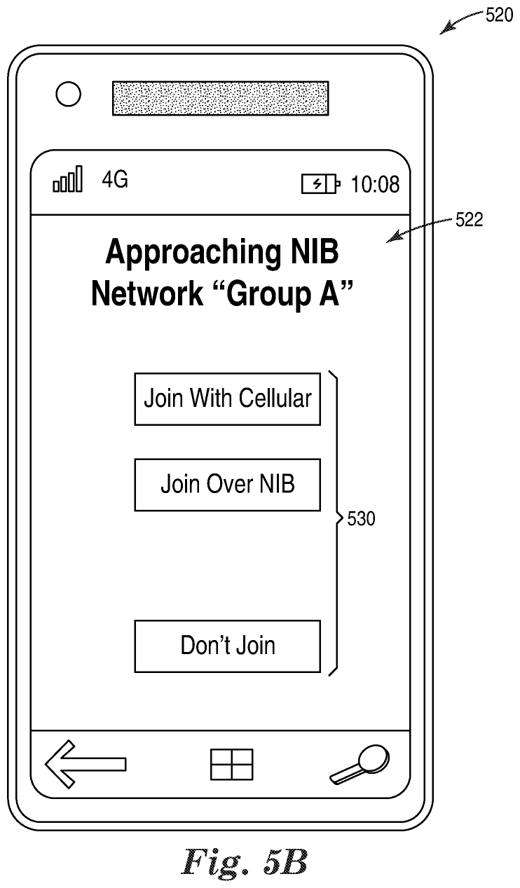

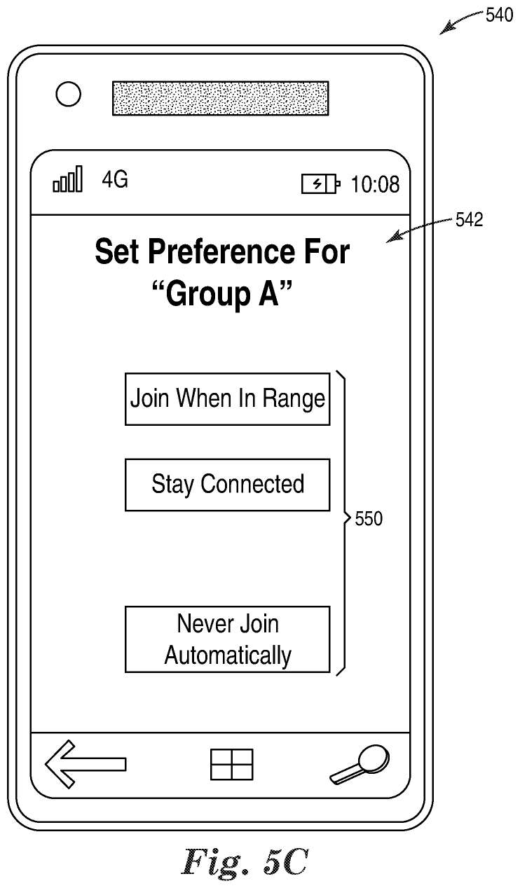

A number of communication preferences may be stored in a preference database 240, and accessed based on identifying a user, using user identifier 230, or by identifying an event, e.g. by knowing a location of a PPE device, an operation that a user is engaged in, or by a time, or implemented in response to another trigger 246, such as a safety manager override. As described herein, user-specified preferences may be set by a user, for example using an application with a user interface, such as those described in FIGS. 5A and 5B.

Preference database 240 may be stored locally, on a PPE device, as illustrated in FIG. 2. However, it is expressly contemplated that preference database 240 may be remote from a PPE device and, for example, accessed at the beginning of a shift in response to a user being identified by user identifier 230.

In some scenarios, it may not be possible or preferable to automatically select a communication preference for an individual. For example, referring back to FIG. 1B, it may not be known whether worker 10N is going to the second group of workers, and will want to join network 40B, is going to station 50 and will want to remain connected to network 40A, or somewhere else entirely and will want to disconnect from network 40A and not connect to 40B. In scenarios where a preference is unclear, or if the preference is set not to automatically switch, an option generator 270 may generate an indication that a network change preference is needed. The option generator 270 may generate an audio indication 272, for example using a speaker 294 to indicate that user 10N has an option to stay in network 40A, enter network 40B, or leave network 40A and not enter network 40B. Communication component 290 may indicate a selection made by the user received by a microphone 292. This may allow a user to make a communication network selection hands-free

However, it is also possible that option generator 270 generates other indicia. For example, if the PPE device has a heads up display, a visual indicia 274 may be displayed. A user may then be able to respond using microphone 292, or by nodding or shaking their head, which may be detectable by an accelerometer. Haptic feedback 276 may also be provided, e.g. by causing PPE device, or another device, to vibrate when a user is nearing the range limit of network 40B. The haptic feedback 276 may prompt a user to indicate to verbally indicate to “continue” or “leave”, for example.

When joining an existing network, device position selector 250 automatically completes a joining protocol necessary to enter the network. This may include taking a main position 252 on the network, another position 256, or checking available time slots using time slot checker 254. Device position selector 250 may conduct a time slot check periodically and, if appropriate, enter main position 252. Similarly, device position selector 250 may also enter a main position slot in a network generated by network selector 260, in scenarios where a conversation network does not already exist, but is needed for a group of workers. This may occur at the start of a shift or when a sudden network quality decrease is detected. For example, if there is an ongoing conversation and the network suddenly gets bad, another network may be used to stay connected. Position selection may also occur when the user is alone, with no other devices around.

Communication component 290 is illustrated as a single component integrated into system 200, however it may also be separate from system 200. For example, microphone 292 may be part of a separate PPE device than speaker 294. Communication component 290 may receive a communication, using receiver 296, which may then be provided to speaker 294. Communication component 290 may also generate a communication, using signal generator 298. For example, communication component 290 may receive a signal from another device, e.g. another PPE device, a safety office device, or another device and, based on that signal, causes network selector 260 to select a network. The signal may also be a signal to switch a device position, using device position selector 250.

It is expressly contemplated that preferences may be customizable—for example by an individual worker, a safety officer, a shift supervisor, etc. The preferences could be globally applied to a worksite, for example to always preserve a connection to a conversation network until a worker indicates a desire to leave. Preferences could also be set up by an individual, either using an application interface, responding to verbal or visual cues during set up, etc. Preferences may also be overridden, for example, by an authorized manager, safety officer, etc.

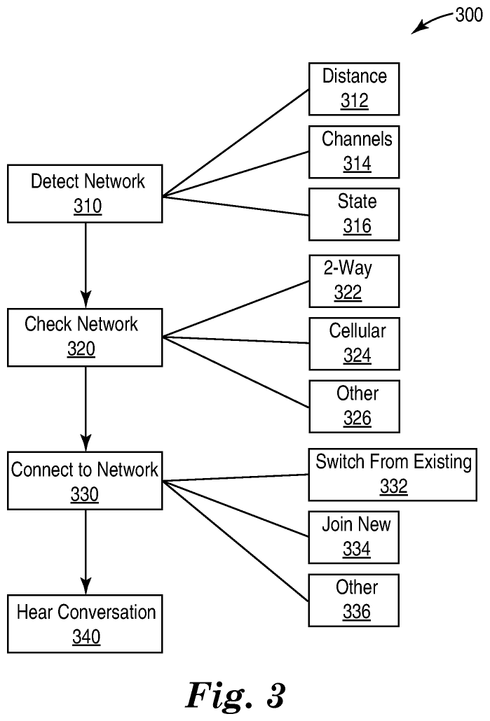

FIG. 3 illustrates an example method of configuring a communication system in accordance with embodiments herein. Method 300 may be performed automatically by a communication selection system, such as system 200, for example. Method 300 may be performed locally by a processing unit of a PPE device.

In block 310, a network is detected, for example by a network identifier. The network may be detected based on distance 312, e.g. actively searching for networks in range of a device, or may be detected by checking communication channels 314, e.g. checking whether a network exists between a known workgroup based on 2-way radio channels. A state 316 of a communication protocol may also dictate available networks. For example, if a PPE device cannot detect a 2-way radio, or a cellular network is unavailable due to service outage, etc., it will not be detectable.

In block 320, detected networks are checked for availability. Generally, worksites use NIB networks as the default, and a switch is happening in order to maintain a worker's connection to the conversation while they are out of range of the NIB network. Therefore, a 2-way radio 322 may be checked for availability. Checking for availability may include checking a power supply of a 2-way radio to ensure it can handle communication needs, or checking a strength of a cellular network 324, for example. Other requirements 326 may also be verified in block 320. Similarly a user may set a preference for a 2-way radio or a cellular network as a default network.

In block 330, the PPE device connects to one of the detected networks. The selection of a network may happen based on stored preferences, based on a preferability of one network (e.g. battery level, network strength, network quality, etc.). Connecting may include switching from an existing network, as illustrated in block 332, by entering the new network and leaving the old network such that a transition is as seamless as possible. Connecting to a new network may include starting a new conversation network, as indicated in block 334. All individual devices from the old network may be notified about the formation of the new network to facilitate a seamless joining.

Having a number of devices in proximity together may cause one of them to form the NIB network. The devices need to be close enough and the network forms automatically. As noted previously, in one embodiment each device is assigned a unique ID number during manufacturing and the device with the lowest number starts the NIB network. However, the devices could also be programmed, for example, such that the device with the highest number starts the NIB network, etc. Other options are expressly contemplated.

Connecting to a new network may also include other features 336. For example, a user may want to stay connected to an old network when the new one is joined. For example, a worker may be leaving a first conversation and entering a second conversation and may, for some time, want to be part of both conversations.

In block 340, the user can hear the conversation on the new network. In some embodiments, the user is on both the old and new network simultaneously for some time (e.g. a few seconds, half a second, less than half a second) to ensure a substantially seamless conversation from a user perspective. In some embodiments the user leaves the old network as soon as a connection is established with the new network. In some embodiments, the user leaves the old network prior to joining the new network, for example with less than one second delay between.

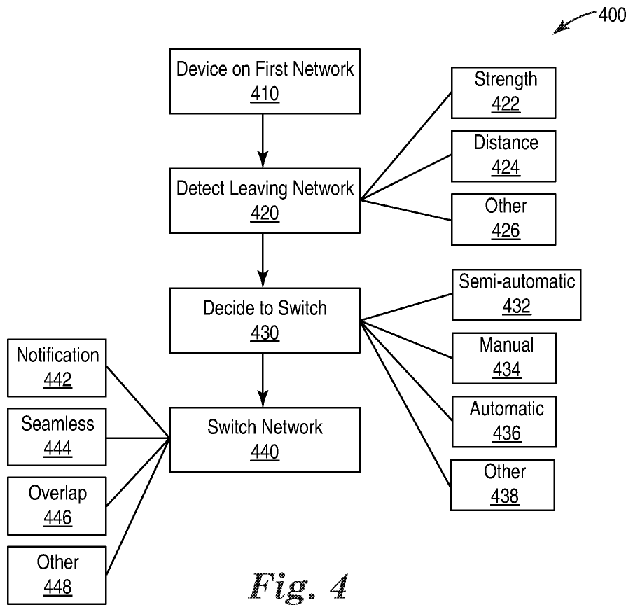

FIG. 4 illustrate an example method of switching a network for a communication device in accordance with embodiments herein. Method 400 may be performed entirely locally on a PPE device, in some embodiments. In other embodiments, some portions of method 400 may be completed remote from the PPE device of concern. Additionally, in some embodiments, method 400 is completely automatically, without consultation of or approval required by a wearer of a PPE device. However, it is expressly contemplated that, in some embodiments, at least some indication is provided to a PPE user that a network switch is needed, is happening, or has happened.

In block 410 a device is on an initial network. Often, the device will be on an NIB network initially because of the ability to carry on a conversation with a number of speakers in close range. However, one difficulty with NIB network communication is the range limit of the network—with a limit of about 10 meters. Further, the initial network may be another suitable wireless network such as cellular, 2-way radio, etc.

In block 420, a device is detected to be leaving, or is on a path to leave the network. This may include a reduction in signal strength 422 of the network—e.g. entering an area of low cellular service. Detecting a device leaving may also be done by measuring a distance 424 of the device from a source of a network. A distance may be detected based on an internal GPS sensor within a device, by using locator beacons in an environment, or another suitable distance measuring system. Other suitable methods 426 for detecting a device leaving a network are also expressly contemplated.

In block 430, a decision is made to switch the device to a second network type. The decision may be made automatically, as indicated in block 436, based on known preferences of the wearer of the PPE, based on preferences set for a worksite, manufacturer defaults, preferences set by a shift leader or safety officer, or another source. The decision may also be at least partially manual, as indicated in block 434, for example initiated by a user through an application interface or another suitable method, such as through voice command prompts.

The switch may also involve notifying or requesting confirmation from a user in a semi-automatic process 432. For example, a PPE device may notify a user, using a device speaker with a message such as “a range limit of the NIB is approaching. Switching to cellular.” Instead of a verbal message, a warning tone may sound in a speaker, in some embodiments. In embodiments where a PPE device has a heads-up display, a notification may be presented on the display using augmented reality techniques.

A semi-automatic process 432 may also require confirmation from a user, in some embodiments. For example, a user may verbally permit or acknowledge a switch, such as “Okay, switch to cellular” or “no, switch to 2-way radio” in response to the previous voice command. A user may also be able to approve/negate a switch nonverbally, for example by nodding or shaking their head in a manner detectable by an accelerometer or other motion sensing device. Additionally, a user may manually activate a switch—e.g. using a button, voice command or other mechanism, to switch between NIB, cellular or two-way radio networks.

The decision to switch networks may also include other considerations 438.

In block 440, the switch from the first network to a new network occurs. The switch may occur with a notification 442 provided to a user, in some embodiments. The switch may be seamless 444, in some embodiments, such that the PPE device drops off the first network and enters the second network without any drop in communication detectable by the PPE wearer. Seamless may also involve some overlap 446, such that the PPE device is, for some amount of time, connected to both the first network and the second network. Switching may also include other features 448, such as reporting a network switch to a database or a second device.

FIGS. 5A-5C illustrates example user interfaces presented to a user of a PPE device in accordance with embodiments herein. FIGS. 5A-5B illustrate interactions that a user of a PPE device may have with a communication network selection system. However, it is expressly contemplated that these are examples only. For example, in some embodiments a user does not have to view an application screen but receives similar prompts and/or options through a heads-up display or as verbal prompts. Additionally, also setting preferences may be presented, for example a suggested set of “better” settings based on history data, or a suggested new group based on location, distance, projected task, etc., for example “would you like to create a new group with worker A and B?”.

FIG. 5A illustrates an example user interface 502 that may be presented to a user on a cellular phone 500, for example when a range limit is nearby and/or it is detected, based on the location and direction of travel of the PPE, that they are approaching the limit of a network range. In the illustrated embodiment, the current network is an NIB network and the user is given prompts 510 to either switch to a cellular network, a 2-way radio network, or to leave the conversation.

FIG. 5B illustrates an example user interface 522 that may be presented on a smartphone 520 with a number of prompts 530. As illustrated, a user may either be in a current conversation network, or not in a current conversation network and may be approaching a different conversation network in progress—named “Group A” in FIG. 5B. For example, “Group A” may be associated with a location or operation within a worksite. A user may be able to join the network immediately, using cellular or 2-way radio or another available network, or may be able to join with NIB as soon as they are within range. A user may also be able to decline the option to join, as illustrated in FIG. 5B.

FIG. 5C illustrates a user interface 542 presented on a smart phone 540. A user is given options 550 to adjust their preferences for Group A. For example, the user may have never previously encountered the individuals of Group A—they may be associated with an operation that the user had not done previously, or a location the user does not normally go to within he worksite, or they may be a newly formed group. The user may be able to provide new or updated preferences for Group A, for example to always join if in NIB range, to stay connected when leaving NIB range, or to not join that group.

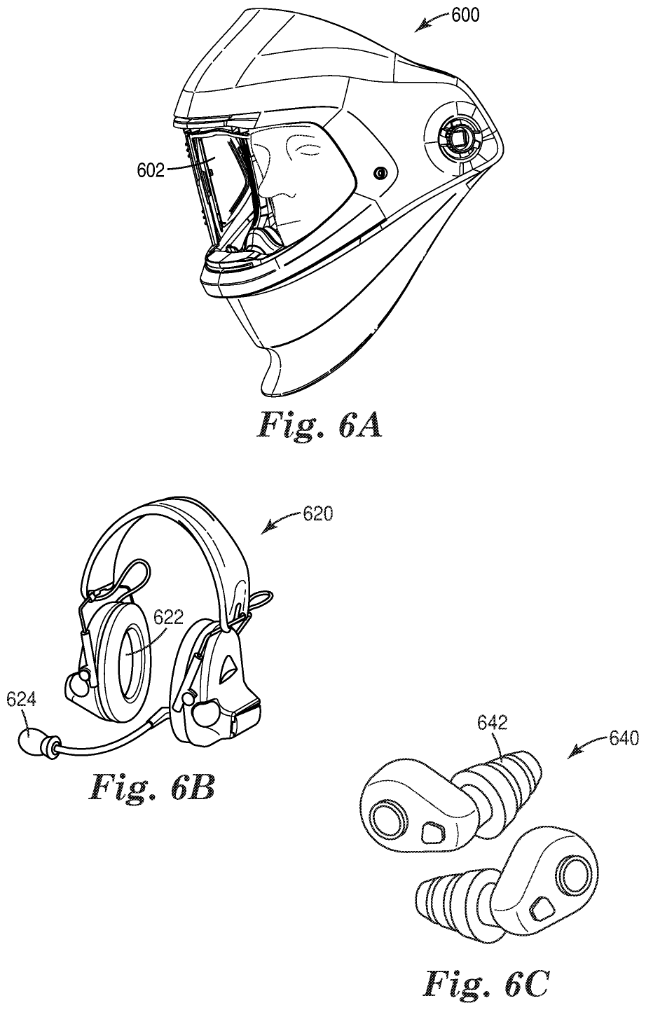

FIGS. 6A-6C illustrate example PPE that may be used in accordance with embodiments herein. However, FIGS. 6A-6C are presented by example only, and are not intended to illustrate an exhaustive list of PPE that may incorporate systems and methods described herein. Any suitable PPE that is compatible with the NIB network and is communicably coupled to a microphone and speakers that can provide communication signals to and from the NIB network.

FIG. 6A illustrates a hood component of a Personal Air Purifying Respirator (PAPR). The illustrated PAPR 600 fully encloses a user's head, separating them from the ambient environment. The PAPR has a microphone inside the hood to pick up a user's voice and either has speakers, or the user wears additional hearing protection within the hood, that include speakers. The user may receive visual prompts 602, if the face shield includes a heads up display. The hood may include an accelerometer or motion sensor that can interpret a user's movements in response to the provided visual prompts. Otherwise the microphone/speaker assist in maintaining the user as part of the conversation.

FIG. 6B illustrates a hearing protection device 620, with a pair of ear muffs 622 that enclose a user's ear and provide a barrier to ambient sound. Earmuffs 622 may include speakers to provide received communication. The hearing protection device also includes a boom microphone 624 that picks up the user's speech. If hearing protection device 620 is the only PPE associated with a user, prompts may only be delivered audibly. However, device 620 may be part of a personal area network of PPE devices associated with a user. If device 620 is worn under hood 600, for example, a user may be able to indicate if they prefer visual or audio prompts or notifications.

FIG. 6C illustrates a hearing protection device 640, a pair of in-ear protection plugs 652 that include speakers that provide received sound to a user's ear. Device 640 may have a microphone capable of picking up speech from the user, or the user may wear a different PPE with a microphone, such as a comms unit, a headset with a boom microphone, a VOX unit, etc.

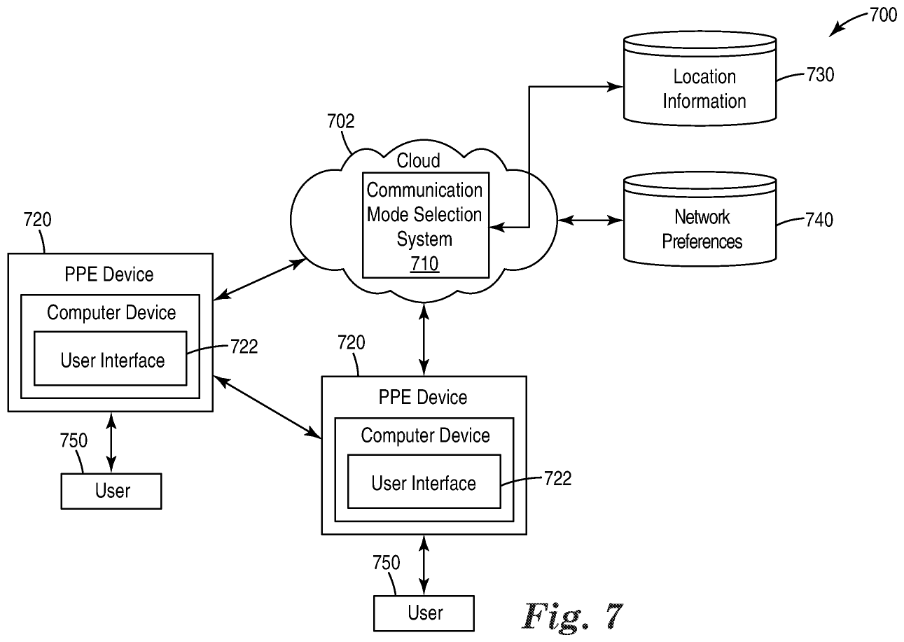

FIG. 7 is a networked architecture for a communication mode selection system 710. Architecture 700 illustrates one embodiment of an implementation of a system 710, however others are possible. In various embodiments, remote servers can deliver services or data over a wide area network, such as the internet, using appropriate protocols, or a shorter range network, such as NIB, Bluetooth®, etc. For instance, remote servers can deliver applications over a wide area network and they can be accessed through a web browser or any other computing component.

Software or components, as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

Further, as described above, in some embodiments it is expressly contemplated that each PPE device 720 includes a system 710, such that communication modes and switches happen locally.

As described herein, based on an indication from system 710, a PPE device 720, may adjust a communication mode in order to keep user 760 in a conversation. The PPE device 720 may also display, or provide a sound notification of the change, using user interface 722.

Further, as illustrated, in some embodiments, PPE devices 720 communicate with each other to make communication mode selections.

FIG. 7 specifically shows that a system 710 can be located at a remote server location 702. Therefore, PPE device 720 accesses those systems through remote server location 702. Operator 750 can PPE device 720, or a separate computing device, such as a mobile phone interact with system 710 or databases 730, 740. For example, user interface 722 may provide an indication of an anticipated network change, an indication that a network change occurred, or an indication of available networks to join.

FIG. 7 shows that it is also contemplated that some elements of systems described herein are disposed at remote server location 702 while others are not. By way of example, storage 730 or 740 can be disposed at a location separate from location 702 and accessed through the remote server at location 702. Regardless of where they are located, they can be accessed directly by PPE 720, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

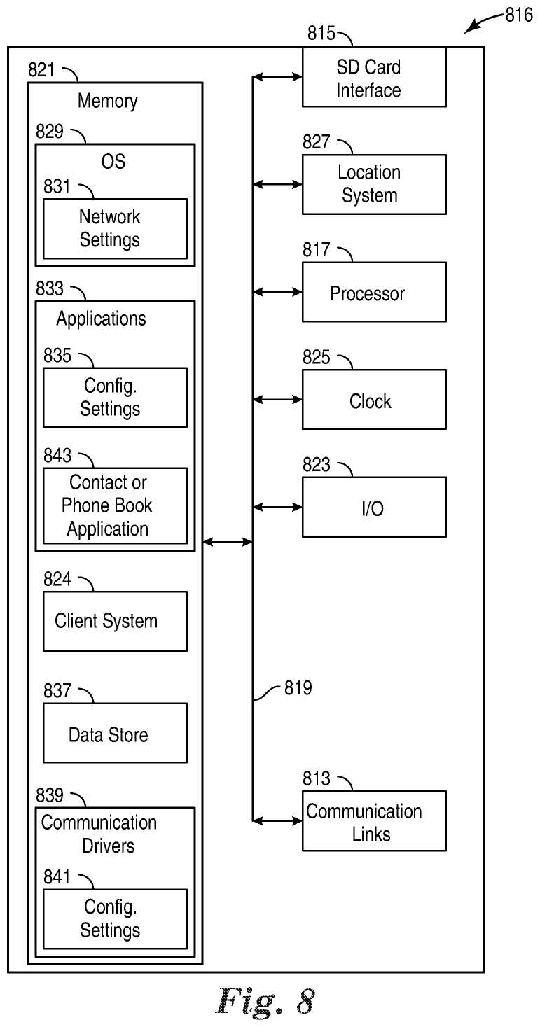

FIGS. 8-10 illustrate example devices that can be used in the embodiments shown in previous Figures. For example, computing devices may be used by a safety officer to review automatically generated checklists by a compliance system in a learning mode, either to modify or confirm them. Computing devices may also be used to review compliance information collected by a compliance checklist system.

FIG. 8 illustrates an example mobile device that can be used in the embodiments shown in previous Figures. FIG. 8 is a simplified block diagram of one illustrative example of a handheld or mobile computing device that can be used as either a worker's device or a supervisor/safety officer device, for example, in which the present system (or parts of it) can be deployed. For instance, a mobile device can be deployed in the operator compartment of computing device for use in generating, processing, or displaying the data.

FIG. 8 provides a general block diagram of the components of a mobile cellular device 816 that can run some components shown and described herein. Mobile cellular device 816 interacts with them or runs some and interacts with some. In the device 816, a communications link 813 is provided that allows the handheld device to communicate with other computing devices and under some embodiments provides a channel for receiving information automatically, such as by scanning. Examples of communications link 813 include allowing communication though one or more communication protocols, such as wireless services used to provide cellular access to a network, as well as protocols that provide local wireless connections to networks.

In other examples, applications can be received on a removable Secure Digital (SD) card that is connected to an interface 815. Interface 815 and communication links 813 communicate with a processor 817 (which can also embody a processor) along a bus 819 that is also connected to memory 821 and input/output (I/O) components 823, as well as clock 825 and location system 827.

I/O components 823, in one embodiment, are provided to facilitate input and output operations and the device 816 can include input components such as buttons, touch sensors, optical sensors, microphones, touch screens, proximity sensors, accelerometers, orientation sensors and output components such as a display device, a speaker, and or a printer port. Other I/O components 823 can be used as well.

Clock 825 illustratively comprises a real time clock component that outputs a time and date. It can also provide timing functions for processor 817.

Illustratively, location system 827 includes a component that outputs a current geographical location of device 816. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 821 stores operating system 829, network settings 831, applications 833, application configuration settings 835, data store 837, communication drivers 839, and communication configuration settings 841. Memory 821 can include all types of tangible volatile and non-volatile computer-readable memory devices. It can also include computer storage media (described below). Memory 821 stores computer readable instructions that, when executed by processor 817, cause the processor to perform computer-implemented steps or functions according to the instructions. Processor 817 can be activated by other components to facilitate their functionality as well. It is expressly contemplated that, while a physical memory store 821 is illustrated as part of a device, that cloud computing options, where some data and/or processing is done using a remote service, are available.

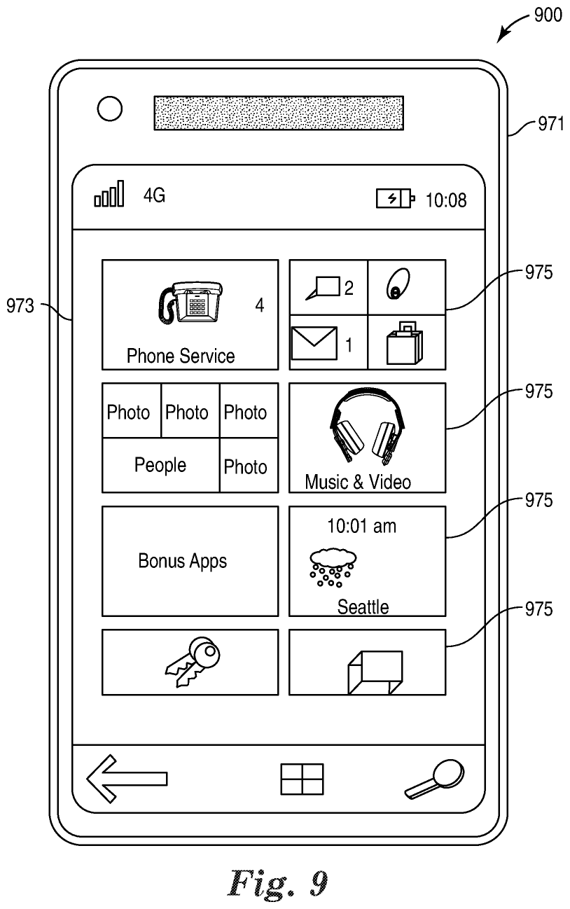

FIG. 9 shows that the device can also be a smart phone 971. Smart phone 971 has a touch sensitive display 973 that displays icons or tiles or other user input mechanisms 975. Mechanisms 975 can be used by a user to run applications, make calls, perform data transfer operations, etc. In general, smart phone 971 is built on a mobile operating system and offers more advanced computing capability and connectivity than a feature phone. Note that other forms of the devices are possible.

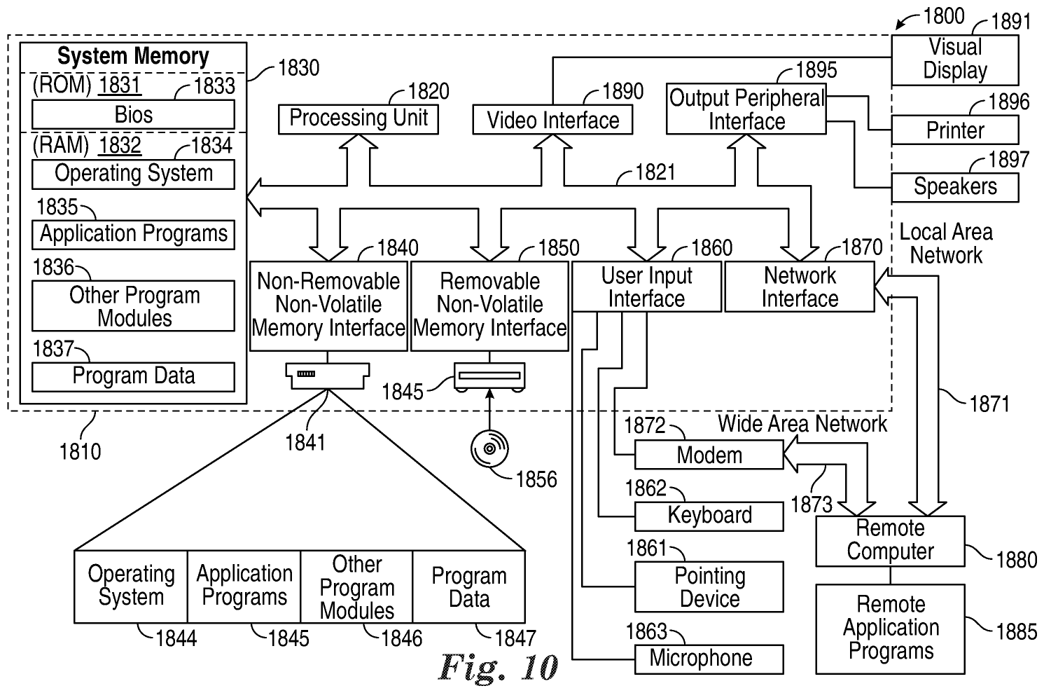

FIG. 10 is one example of a computing environment in which elements of systems and methods described herein, or parts of them (for example), can be deployed. With reference to FIG. 10, an example system for implementing some embodiments includes a general-purpose computing device in the form of a computer 1010. Components of computer 1010 may include, but are not limited to, a processing unit 1020 (which can comprise a processor), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. Memory and programs described with respect to systems and methods described herein can be deployed in corresponding portions of FIG. 10.

Computer 1010 typically includes a variety of computer readable media. Computer readable media can be any available media that can be accessed by computer 1010 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1030 includes computer storage media in the form of volatile and/or nonvolatile memory such as read only memory (ROM) 1031 and random-access memory (RAM) 1032. A basic input/output system 1233 (BIOS) containing the basic routines that help to transfer information between elements within computer 1010, such as during start-up, is typically stored in ROM 1031. RAM 1232 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable and volatile/nonvolatile computer storage media. By way of example only, FIG. 10 illustrates a hard disk drive 1041 that reads from or writes to non-removable, nonvolatile magnetic media, nonvolatile magnetic disk 1052, an optical disk drive 1055, and nonvolatile optical disk 1056. The hard disk drive 1041 is typically connected to the system bus 1021 through a non-removable memory interface such as interface 1040, and optical disk drive 1055 are typically connected to the system bus 1021 by a removable memory interface, such as interface 1050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite receiver, scanner, or the like. These and other input devices are often connected to the processing unit 1020 through a user input interface 1060 that is coupled to the system bus but may be connected by other interface and bus structures. A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections, such as a Local Area Network (LAN) or Wide Area Network (WAN) to one or more remote computers, such as a remote computer 1280.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. In a networked environment, program modules may be stored in a remote memory storage device. FIG. 10 illustrates, for example, that remote application programs 1085 can reside on remote computer 1080.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

A communication selection system for a personal protective network is presented. The system includes a network detector that detects an available network for a second device in the personal protective network. The system also includes a network selector that selects the available network and switches a communication component from using a first device, on a first network to the second device on the available network. The switch is based on an indication that the communication device is leaving a range of a current network communication protocol. A communication component stops using the first network communication protocol and starts using the available network communication protocol. The switch from the current network to the available network happens substantially seamlessly.

The system may be implemented such that the communication selection system is incorporated into a processing unit of a personal protective equipment device.

The system may be implemented such that the communication device includes a speaker that broadcasts a received communication.

The system may be implemented such that the communication device includes a microphone that captures produced sound by a wearer of the communication device.

The system may be implemented such that the current network is an NIB network, a 2-way radio network or a cellular network.

The system may be implemented such that the network selector automatically selects the available network based on an indication that the first device is approaching a range limit of the current network.

The system may be implemented such that the communication component automatically switches from the first network to the available network.

The system may be implemented such that a notification is provided of the switch.

The system may be implemented such that the notification is an audible notification, a visual notification, or a haptic feedback notification.

The system may be implemented such that the notification is provided to a wearer of the communication device.

The system may be implemented such that the notification is provided to a database.

The system may be implemented such that the network selector makes a selection autonomously.

The system may be implemented such that the communication component switches autonomously.

The system may be implemented such that the communication component is incorporated into a hearing protection device.

The system may be implemented such that the hearing protection device and includes level dependent hearing protection.

The system may be implemented such that the hearing protection device includes over-the-ear muffs.

The system may be implemented such that the hearing protection device includes in-ear buds.

The system may be implemented such that the personal protective equipment device is a PAPR.

The system may be implemented such that the personal protective equipment includes an self-contained breathing apparatus.

The system may be implemented such that it includes a network notification component that provides a notification of the available network to a wearer of the communication device.

The system may be implemented such that the notification is a request to switch to the available network, and the communication component switches only after a confirmation is received from the wearer.

The system may be implemented such that the request is provided audibly through a speaker.

The system may be implemented such that the request is provided visually on a user interface or on a heads up display.

The system may be implemented such that the confirmation is an audible confirmation.

The system may be implemented such that the confirmation is a detected motion of the wearer.

The system may be implemented such that the notification is provided before the communication component switches.

The system may be implemented such that the notification is provided after the communication component switches.

The system may be implemented such that the communication component, at some point, is using both the current and available communication protocols.

The system may be implemented such that seamless includes switching between the current and available networks such that a current conversation is not disrupted.

The system may be implemented such that the network selector selects the available network from a set of available networks.

The system may be implemented such that the network selector selects the available network based on: a network preference of a wearer of the communication device, a strength of the available network, or a range of the available network.

The system may be implemented such that the current network is an NIB network and the available network is a cellular network.

The system may be implemented such that using the available network protocol includes the network selector retrieving contact information for a user in the NIB network. The contact information includes a telephone number.

The system may be implemented such that the communication component causes a cellular phone associated with the communication device to call the cellphone number.

The system may be implemented such that the communication component is communicatively coupled to the cellular phone using a wireless protocol.

A personal protection device is presented that includes a communication component configured to receive a signal indicative of communication. The device also includes a speaker configured to broadcast the communication signal. The device also includes a network selector that is configured to select a wireless network for the communication component to connect. The communication component operates using a communication protocol based on the selected wireless network. The network selector is configured to select the wireless network based on a stored network preference.

The PPE device may be implemented such that the stored network preference is a preference to continue an ongoing communication when a first network is no longer available.

The PPE device may be implemented such that the network selector causes the communication component to switch to the selected communication protocol automatically.

The PPE device may be implemented such that the switch is in response to a received confirmation from the user.

The PPE device may be implemented such that a notification generator provides a notification to the user of the selected network.

The PPE device may be implemented such that the notification is provided after the switch.

The PPE device may be implemented such that the notification is an audible notification.

The PPE device may be implemented such that the notification includes haptic feedback.

The PPE device may be implemented such that the communication component is configured to receive communication signals using an NIB protocol, a cellular protocol or a 2-way radio protocol.

The PPE device may be implemented such that it includes a microphone configured to capture a speech indication from a user of the hearing protection device.

The PPE device may be implemented such that the communication component starts using the selected communication protocol at substantially the same time it stops using a second communication protocol associated with the first network.

The PPE device may be implemented such that the communication component, at some point, uses both the selected communication protocol and a second communication protocol associated with the first network.

A method of switching communication modes of a communication system is presented that includes operating a first communication device on a first communication network, such that a communication component uses a first communication protocol. The method also includes detecting that the first communication device is approaching a range limit of the first communication network. The method also includes selecting, using a network selector, a second communication network for a second communication device, with a second communication protocol. The method also includes switching the communication component from operating the first communication device on the first communication protocol to the second communication device using the second communication network.

The method may be implemented such that the steps of operating, detecting, selecting and switching are completed by components within the communication system.

The method may be implemented such that the steps are completed by a processing unit of the communication system.

The method may be implemented such that detecting includes detecting a signal strength of the first communication network and comparing the signal strength to a threshold signal strength.

The method may be implemented such that detecting includes detecting a location of the first communication device relative to the first communication network.

The method may be implemented such that detecting further includes detecting that a distance between the first communication device and the first communication network is increasing.

The method may be implemented such that the location of the first communication device is detected by a GPS sensor associated with the communication device.

The method may be implemented such that the location of the first communication device is received from a beacon.

The method may be implemented such that the steps of detecting, selecting and switching are done automatically.

The method may be implemented such that it includes notifying a user of the first communication device of the detected range limit.

The method may be implemented such that it includes generating an indication of the second communication network, and receiving approval from the user to switch to the second communication network.

The method may be implemented such that the notification is provided after the switching step.

The method may be implemented such that the notification is provided before the switching step.

The method may be implemented such that the communication component switches to the second communication protocol after dropping the first communication protocol.

The method may be implemented such that the communication component switches to the second communication protocol while the first communication protocol is still active.

A method of maintaining communication between a first PPE device and a second PPE device includes operating the first PPE device using a first communication protocol and operating the second device using the first communication protocol. The method also includes detecting that the first communication protocol is unsuitable for the first PPE device. The method also includes detecting a second communication protocol, using a second device that the first PPE device can switch to. The method also includes switching the first PPE device to the second communication protocol while maintaining a connection to a network of the second PPE device.

The method may be implemented such that the second device is on an NIB network with a third device, the second device is a cellular phone associated with a user of the first PPE device, and the first PPE device switches to a cellular or 2-way radio communication protocol.

The method may be implemented such that the first PPE device connects to the cellular network, using the second communication protocol, before ending an NIB communication link to the NIB network.

The method may be implemented such that unsuitable includes the first PPE device leaving a range of the first communication protocol.

The method may be implemented such that detecting includes detecting a reduced strength of a network using the first communication protocol.

The method may be implemented such that detecting includes detecting a location of the first PPE device.

The method may be implemented such that detecting includes detecting a change in the location of the first PPE device.

1. A communication selection system for an article of personal protective equipment comprising:
a network detector that detects an available network for a second device in a personal protective wireless network;
a network selector that selects the available network and switches a communication component from using a first device, on a first network, to the second device on the available network, wherein the switch is based on an indication that the communication device is leaving a range of a current network communication protocol;
wherein a communication component stops using the first network communication protocol and starts using the available network communication protocol, and wherein the switch from the current network to the available network happens substantially seamlessly; and
wherein the first device comprises a microphone that captures produced sound by a wearer of the first device, and a speaker that broadcasts a received communication.

2. The system of claim 1, wherein the communication selection system is incorporated into a processing unit of the article of personal protective equipment.

3-4. (canceled)

5. The system of claim 1, wherein the current network is an NIB network, a 2-way radio network or a cellular network.

6. The system of claim 1, wherein the network selector automatically selects the available network based on an indication that the first device is approaching a range limit of the current network.

7. The system of claim 6, wherein the communication component automatically switches from the first network to the available network.

8-10. (canceled)

11. The system of claim 1, wherein the communication component is incorporated into a hearing protection device, the hearing protection device comprising over-the-ear muffs or in-ear buds, and wherein the hearing protection device comprises level dependent hearing protection.

12-14. (canceled)

15. The system of claim 11, wherein the personal protective equipment device is a PAPR.

16. (canceled)

17. The system of any of claims 1-16, and further comprising:
a network notification component that provides a notification of the available network to a wearer of the communication device; and
wherein the notification comprises a request to switch to the available network, and wherein the communication component switches only after a confirmation is received from the wearer.

18-19. (canceled)

20. The system of claim 1, wherein seamless comprises switching between the current and available networks such that a current conversation is not disrupted.

21. The system of claim 1, wherein the network selector selects the available network from a set of available networks.

22. The system of any of claim 1-21, wherein the current network is an NIB network and the available network is a cellular network, wherein using the available network protocol comprises the network selector retrieving contact information for a user in the NIB network, wherein the contact information comprises a telephone number, and wherein the network selector is configured to initiate a telephone call over the cellular network.

23. (canceled)

24. A personal protection device comprising:
a microphone configured to capture a speech indication from a user of the hearing protection device;
a communication component configured to receive a signal indicative of communication over a wireless network;
a speaker configured to broadcast the communication signal;
a network selector that is configured to select the wireless network for the communication component to connect to, and wherein the communication component operates using a communication protocol based on the selected wireless network; and
wherein the network selector is configured to select the wireless network based on a stored network preference.

25. The PPE device of claim 24, wherein the stored network preference is a preference to continue an ongoing communication when a first network is no longer available.

26. The PPE device of claim 25, wherein the network selector causes the communication component to switch to the selected communication protocol automatically.

27. The PPE device of claim 26, wherein the switch is in response to a received confirmation from the user.

28-30. (canceled)

31. The PPE device of claim 1, wherein the communication component starts using the selected communication protocol at substantially the same time it stops using a second communication protocol associated with the first network.

32. A method of switching communication modes of a communication system, the method comprising:
operating a first communication device on a first communication network, such that a communication component uses a first communication protocol;
detecting a signal strength of the first communication network and comparing the signal strength to a threshold signal strength, wherein the threshold signal strength is indicative of a range limit of the first communication device;
selecting, using a network selector, a second communication network for a second communication device, with a second communication protocol; and
switching the communication component from operating the first communication device on the first communication protocol to the second communication device using the second communication network.

33-35. (canceled)

36. The method of claim 32, and further comprising: notifying a user of the first communication device of the detected range limit.

37. The method of claim 32, wherein the communication component switches to the second communication protocol after dropping the first communication protocol.

38. The method of claim 32, wherein the communication component switches to the second communication protocol while the first communication protocol is still active.

39. (canceled)
